(19) United States
(12) Patent Application Publication
(10) Pub. No.: US 2018/0206666 A1
(43) Pub. Date: Jul. 26, 2018

(54) Modular Beverage Preparation Device for Portable and Stationary Use

(71) Applicant: Nestec S.A, Vevey (CH)

(72) Inventors: Alexandre KOLLEP, Lutry (CH); Nicolas DELAY, Cully (CH)

(21) Appl. No.: 15/128,709

(22) PCT Filed: May 8, 2015
(86) PCT No.: PCT/EP2015/030139

§ 371 Date: Sep. 23, 2016

(30) Foreign Application Priority Data
May 12, 2014 (EP) 14167845.8

(51) Int. Cl. A47J 31/00; A47J 31/40; A47J 31/46

(52) U.S. Cl. CPC A47J 31/005; A47J 31/46; A47J 31/407

(57) ABSTRACT

The invention relates to a portable beverage preparation device for preparing a beverage from an ingredients containing capsule, the device comprising: a beverage brewing unit for receiving the capsule and preparing the beverage from the ingredients within the capsule by means of injection of liquid into the capsule, a liquid reservoir designed for holding a predefined liquid volume suitable for preparing the beverage, a pump unit adapted for providing pressurized liquid to the beverage brewing unit, and heating means arranged within the liquid reservoir and adapted for heating the liquid volume, wherein the device further comprises a multifunctional connector adapted for selectively connecting the device electrically and mechanically to a remote power source.

### FIELD OF THE INVENTION

The present invention relates to a modular beverage preparation device for preparing a beverage from a beverage ingredients containing capsule. In particular, the present invention relates to a portable beverage preparation device for stationary and mobile use.

### BACKGROUND OF THE INVENTION

Devices for preparation of a beverage such as coffee or tea from ingredients containing capsules are well-known in the prior art. These devices are generally stationary devices equipped with a liquid tank, a pump and heating means in order to provide pressurized, heated liquid through a capsule inserted into the device. The liquid is injected into the capsule and will interact with the ingredients provided in the capsule. The resulting beverage is then drained from the capsule and may be collected in a dedicated receiving vessel.

A drawback of the known systems is the fact that these devices are designed for stationary use only. This means that the device has to be placed at a fixed location within the household, close to a main power supply. In addition, the device has to be placed close to a water supply in order to enable filling or re-filling of the liquid into the liquid tank of the device. The beverage preparation can thus only be carried out at the predefined stationary location of the device.

Therefore, portable devices have been proposed which enable the preparation and provision of a hot beverage such as in particular a coffee beverage at remote places.

EP 1 277 428 for example relates to a portable espresso coffee machine designed for a low-voltage vehicle, comprising a water reservoir connected to a pump to convey water to a heating element, which itself is connected to an extraction head for a portion of coffee. The device is adapted for being used in conjunction with a low voltage source of between 12 to 50 Volts such as present e.g. in a car or a boat. Further, the device is adapted for reducing or cutting-off the heating of the heating element in case the pump is activated during beverage preparation.

US 2009/0029021 relates to a portable device for brewing a coffee beverage, the device comprising a water tank, a housing including a chamber presenting a hot water feed nozzle and an opening through which a fill of brew preparation can be inserted, a closure part for closing said chamber, means connected to the tank to act during a brewing cycle to deliver a certain volume of water that has been raised to a brewing temperature from said tank to said chamber, and a brew outflow orifice from which the resulting beverage may be poured into a suitable receiving vessel. The device comprises an optionally re-chargeable battery for powering a pump and water heating means, which battery may be arranged in a handle of the device.

WO 2011/135539 relates to a beverage preparation machine comprising a fixed part and a movable part which can be coupled and uncoupled to/from each other and are provided with respective cooperating means for providing electric and fluid connection. The movable part of the machine comprises water inlet means, a pump, a dedicated boiler connected to the pump and a brewing chamber for the coffee beverage. Water provided to the water inlet means at ambient temperature is continuously heated in the boiler of the machine in order to provide heated water to the brewing chamber. When connected to the fixed part of the device, the pump and the boiler of the movable part are connected with a liquid reservoir of the fixed part.

A drawback of this machine is the relative large dimensions of the movable part of the device that limit its versatility as portable device. In addition, the boiler arrangement for constantly heating the water leads to a relatively high energy consumption as not only the amount of liquid necessary for preparation of a serving of the coffee beverage is heated, but also the following water which replaces this amount in the boiler of the machine.

In view of the known prior art appliances, the present invention seeks to address the problem of providing a beverage preparation device and a system enabling an enhanced versatility and providing for a reduced energy consumption of the device. The present in also seeks to address further problems as will become apparent in the following description.

### OBJECT AND SUMMARY OF THE INVENTION

In a first aspect, the invention relates to a portable beverage preparation device for preparing a beverage from an ingredients containing capsule, the device comprising: a beverage brewing unit for receiving the capsule and preparing the beverage from the ingredients within the capsule by means of injection of liquid into the capsule, a liquid reservoir designed for holding a predefined liquid volume suitable for preparing the beverage, a pump unit adapted for providing pressurized liquid to the beverage brewing unit, and heating means arranged within the liquid reservoir and adapted for heating the liquid volume, wherein the device further comprises a multifunctional connector adapted for selectively connecting the device electrically and mechanically to a remote power source.

The invention enables the provision of a compact beverage preparation machine having the heating means arranged directly in the liquid reservoir of the device. Accordingly, the required space for the individual components within the device is reduced. At the same time, the versatility of the device is increased. Thereby, the single multifunctional connector of the device enables a compact embodiment as well as providing for the selective connection to a plurality of different power sources in order to enable e.g. a portable or stationary use of the device. Moreover, the energy consumption of the device is reduced as only the amount of liquid respectively the liquid volume provided in the liquid reservoir is heated.

It is noted that the term “portable” beverage preparation device is to be understood as suitable for being used at remote places by contrast to a stationary beverage preparation device. Thereby, portable means in particular that a human can easily and conveniently carry the device e.g. by hand or in a small suitcase. The device is preferably void of a large liquid reservoir that would significantly add to the weight and size of the beverage preparation device.

The heating means are preferably adapted to be activated in response to a command of the user of the device. Thereby, the heating means are preferably activated by the user shortly before the injection of the liquid into a capsule placed into the brewing unit. This may be obtained manually upon pressing a dedicated activation button of the heating means or automatically upon activating the device. The heating means are preferably designed to heat the volume of liquid contained in the liquid reservoir to a predefined temperature, which preferably lies between 85 and 95° C.

In a preferred embodiment, the heating means are preferably designed for heating the liquid volume contained in the reservoir to about 90° C. in 2-4 minutes, preferably in about 3 minutes after activation. The heating means of the device preferably have a power of 1800W.

In a preferred embodiment, the liquid reservoir of the device is designed for holding a volume of liquid suitable for preparing a single serving of the beverage. The liquid reservoir preferably comprises a volume of between 30 to 60 ml, preferably between 35 and 45 ml. In a particularly preferred embodiment, the liquid reservoir comprises a liquid volume to prepare a cup of espresso-type beverage. Due to a relatively small volume of the liquid reservoir, heating of the liquid contained therein is accelerated.

The multifunctional connector of the device is preferably adapted for electrically and mechanically connecting the device to two or more of the group consisting of a docking station, a battery unit, and a low voltage power cable. Thereby, these entities are preferably designed to function as power source for the operation of the device.

The multifunctional connector is preferably void of any fluid connection or fluid communication means.

In a preferred embodiment, the portable device is adapted at least for mobile use in conjunction with the battery unit, for a virtual mobile use, preferably in conjunction with a car power adapter, and for stationary use in conjunction with the docking station.

The device is preferably adapted for being operated by a DC input current supplied by the multifunctional connector. Thereby, the device is preferably void of any further electrical supply means. This means that the device respectively the electric components of the device are electrically driven only by the DC input current provided via the multifunctional connector.

The device is preferably adapted for receiving a DC input current of preferably 12 to 15 Volts. A dedicated docking station and/or power adapter to which the device may be connected via its multifunctional connector preferably comprises and AC/DC power converter which provides adequate input voltage to the device.

The beverage preparation device is preferably designed for preparing hot beverage and in particular espresso-type coffee at high pressure. Thereby, the device is designed for providing high water pressure supply and high water temperature setting. The device is preferably designed for preparing a beverage at a high pressure of between 10 to 15 bar. The heating means of the device preferably comprises two cartridge heaters designed for being supplied with 12 Volts nominal voltage.

The pump of the device is preferably a membrane pump. The pump is preferably vibration-decoupled from a housing of the device. The membrane pump is preferably designed to enable the provision of the preferred pressure between 10 to 15 bar while at the same time it can be driven by means of a low DC voltage electrical motor. It is noted that the use of a membrane pump prevents cavitation problems due to its flexibility.

The device preferably comprises a user interface which comprises at least one start/stop button. The button is preferably a switch with background lighting designed for enabling a relatively simple feedback concerning the operation state of the device to the user. The use of a simple switch or button with e.g. background lighting enables the minimization of the power consumption by the user interface. In particular, the switch may blink during preheating of the liquid such as water in the reservoir and turn to a ready-mode, e.g. with continuous lightening, when the water is at the brewing temperature. This can be sensed by a dedicated temperature sensor of the device. The switch may be designed for indicating by colour change, the power status of the device. In particular, a red coloured switch may relate to an insufficient available power such as low battery installed; a green coloured switch may relate to a correctly energized device on any electric power supply.

In a preferred embodiment, the device further comprises connection means for selectively connecting to a receptacle and for dispensing the resulting beverage from the brewing unit to the receptacle. Thus, the connection means preferably comprise integrally formed beverage dispensing means such as an integrally formed beverage dispensing outlet for providing the resulting liquid from the brewing unit to the receptacle. The beverage dispensing means preferably protrude from an upper portion of the beverage brewing unit. In a particularly preferred embodiment, the beverage dispensing means protrude from a support surface for a receptacle arranged above the brewing unit. The support surface is preferably a plane and/or round surface arranged at a top portion of the beverage preparation device.

Note that directions and orientations such as e.g. the terms “upper”, “lower”, “above” and “below” are to be understood as referring to a working state of the portable beverage preparation device and not to an orientation of the device during transport or storage.

In a working state of the portable beverage preparation device, the brewing unit is arranged above the liquid reservoir and the pump in the beverage preparation device.

The beverage dispensing means are preferably arranged above the beverage brewing unit. A receptacle to be filled is preferably arranged above the beverage brewing unit and the beverage dispensing means. In a particularly preferred embodiment, at least the pump, the beverage brewing unit and the beverage dispensing means of the device are preferably arranged essentially vertically, such as in particular vertically stacked within the device.

The flow path of liquid through the beverage brewing unit and the beverage dispensing means is preferably in a common direction. In particular, the flow path of liquid from the pump of the device to the beverage brewing unit and the beverage dispensing means is in a common direction. Thereby, in a working state of the beverage preparation device, the flow path of liquid through the above-indicated components of the device is preferably orientated vertically against gravity. Accordingly, a receptacle connected to the beverage dispensing means will be filled from below with the dispensed beverage.

According to such an arrangement, the distances between the individual components of the device are minimized such as to obtain a very compact arrangement of the beverage preparation device. Thereby, also the tubing necessary to fluidly connect the individual parts of the device may be shortened and hence, the risk of contamination with bacteria or the like is minimized.

The brewing unit of the device is preferably designed to accommodate a rotational-symmetric capsule comprising a truncated-cone shaped body portion and a membrane connected to a circumferential rim portion of the body portion and constituting an outlet face thereof. The capsule is arranged within the brewing unit such that the circumferential rim portion and the membrane connected thereto are arranged at the upper side of the capsule.

A further aspect of the invention relates to a portable beverage preparation device for preparing a beverage from an ingredients containing capsule, the device comprising a beverage brewing unit for receiving the capsule and preparing the beverage from the ingredients within the capsule by means of injection of pressurized liquid into the capsule, a lid member selectively connectable to the brewing unit in order to enclose a capsule provided thereto, wherein the lid member preferably comprises beverage dispensing means designed to selectively connect to a receptacle, preferably to a bottom of a receptacle, and wherein the beverage brewing unit is arranged moveable within a housing of the device such as to selectively open a fluid-connection from the brewing unit to a fluid reservoir of the device.

Accordingly, in case of the open fluid-connection from the brewing unit to the fluid reservoir, refilling of the fluid reservoir of the device via filling of liquid into the empty brewing unit is enabled. A user may thus remove the lid member from the brewing unit respectively the housing of the device and simply fill a predefined amount of liquid into the brewing unit in order to refill the liquid reservoir. Hence, a dedicated separate aperture or valve means at the device suitable for refilling purposes of the liquid reservoir may be omitted.

In a preferred embodiment, the fluid-connection from the brewing unit to the fluid reservoir is opened dependent on the provision of the lid member to the device respectively the brewing unit. Thereby, in case no lid member is arranged at the device, the beverage brewing unit is preferably urged in a direction away from the fluid reservoir such as to open a dedicated valve means, e.g. an annular passage enabling fluid flow from the beverage brewing unit to the liquid reservoir. This may be obtained by spring members that are arranged at the brewing unit. Upon closing of the lid member onto the device respectively the brewing unit, the brewing unit is urged in a direction towards to fluid reservoir, whereby the valve means, e.g. the annular fluid passage from the brewing unit to the liquid reservoir is closed.

In a further aspect, the invention relates to a beverage preparation kit respectively a beverage preparation system, the kit respectively the system comprising a beverage preparation device as described above, a docking station and a battery unit, wherein the docking station and the battery unit comprise the same connection means adapted for being selectively connected electrically and mechanically to the multifunctional connector of the device.

The connection means are preferably void of any fluid connection.

In a preferred embodiment, the kit further comprises a low voltage power cable and/or a car power adapter having the same connection means than the docking station and the battery unit and which are adapted for being electrically and mechanically connected to the multifunctional connector of the device.

The docking station preferably comprises at least one charging member respectively charging dock to which the connection means of the battery unit of the system may be connected for charging. The docking station is preferably designed for providing an electrical and mechanical connection for the portable beverage preparation device and at least one battery unit at the same time. The docking station is preferably designed for being connected to the mains. Thereby, the docking station is preferably equipped with an AC/DC power converted that is adapted for providing a DC output voltage to the connection means of the station. In a preferred embodiment, the docking station is adapted for providing a DC output voltage of 12 to 15 Volts to the connection means of the station, to which the portable device may be connected.

The docking station is preferably equipped with a graphical user interface which enables the provision of information to a user regarding the charging state of any battery unit connected to the station. Further, the graphical user interface is preferably designed for enabling the operation of the beverage preparation device when connected to the docking station. The graphical user interface may further be designed for providing feedback information regarding the operating state of the beverage preparation device when connected to the station.

In a preferred embodiment, the kit further comprises a receptacle designed for being selectively connected to a dedicated connection means respectively to the beverage dispensing means of the portable device. Thereby, the portable device and/or the receptacle are adapted for being selectively connected in at least two different positions, a beverage delivery position and a receptacle storage position.

The receptacle for being connected to the device preferably comprises inlet means such as a valve or selectively openable aperture that is integrally formed in a wall of the receptacle, such as preferably in the bottom wall of the receptacle. The inlet means may for example be a valve or a self-closing membrane. The closing strength of the valve or the membrane is preferably selected to ensure that it can withstand at least the pressure exerted on it by liquid in the receptacle, in case the receptacle is filled completely, without any leakage. The valve means of the receptacle are preferably designed to interact with dedicated connection means respectively with the beverage dispensing means of the portable device in order to enable a fluid connection from the portable device to the interior of the receptacle.

### BRIEF DESCRIPTION OF THE DRAWINGS

Further features, advantages and objects of the present invention will become apparent for a skilled person when reading the following detailed description of embodiments of the present invention, when taken in conjunction with the figures of the enclosed drawings.

FIG. 1a is a perspective side view of a preferred embodiment of the system according to the invention, the system comprising a docking station, a portable beverage preparation device and a battery unit.

FIG. 1b is a perspective exploded assembly drawing of the system as shown in FIG. 1a, the system further comprising a car power connector.

FIG. 2 relates to a sectional side view of a preferred embodiment of the portable beverage preparation device in a storage or transport position.

FIGS. 3a to 3c are sectional side views of the portable beverage preparation device during provision of a capsule into the brewing unit of the device.

FIG. 3d is a partial sectional side view of the device in an operation state of the device, i.e. during beverage production.

FIG. 4a is a perspective view from above of a preferred embodiment of the beverage brewing unit of the beverage preparation device

FIG. 4b is a perspective view from below of a preferred embodiment of the beverage brewing unit of the device.

FIG. 4c is a perspective side view of a preferred embodiment of a lid member for being connected to the housing of the device.

FIGS. 5a and 5b relate to a preferred embodiment of a receptacle for being connected to the device according to the invention, the receptacle comprising selective openable valve means.

FIG. 5c relates to a bottom view of a preferred embodiment of the receptacle as shown in FIGS. 5a and 5b.

### DETAILED DESCRIPTION OF THE FIGURES

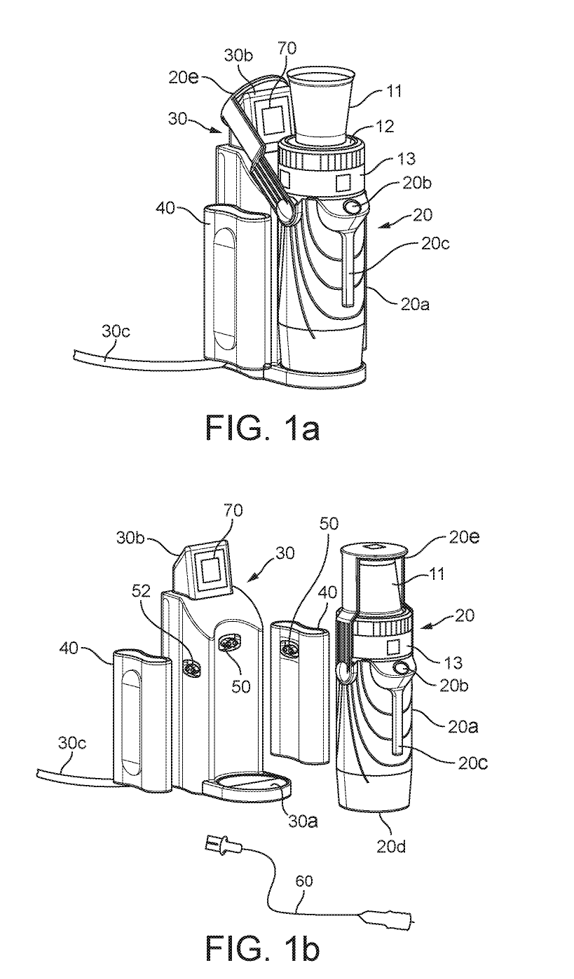

FIG. 1a relates to a preferred embodiment of a system according to the invention, the system comprises a portable beverage preparation device 20, a docking station 30 and a battery unit 40. The system may further comprise a power cable such as a car power cable 60 (see FIG. 1b) designed for being selectively connected directly to the portable device 20.

The portable device 20 is adapted for being electrically and mechanically connected to a docking station 30 which is electrically connected to the mains via a power cable 30c. Thereby, the docking station comprises an AC/DC power converter for converting the AC input current as provided by the mains to preferably a DC output current of low voltage. In particular, the AC/DC power converter of the docking station 30 is adapted for converting an AC input of 110-220 Volts, 2.2 Ampere and 50-60 Hz to an output current of between 12-16 Volts, preferably 15 Volts at 12 Ampere.

For this purpose, the portable device 20 comprises a single multifunctional connector 51 preferably provided at a side surface of a housing 20a of the device to which the different power sources such as the docking station 30, a battery unit 40 or a power cable 60 may be individually connected.

For this purpose, the different power sources 30,40,60 of the system are preferably equipped with the same electrical connection means 50 and which are designed for being selectively connected to the multifunctional connector 51 of the portable device 20. The connection means 50 are preferably formed as male connection elements protruding to a certain extent from the respective power sources 30,40,60. The multifunctional connector 51 is preferably formed as female connection element.

The docking station 30 of the system is preferably designed to operate as charging unit for at least one battery unit 40 of the system. Accordingly, the docking station 30 preferably comprises at least one dedicated connector 52 to which the battery unit 40 may be connected electrically and mechanically via its connection means 50. As shown in FIG. 1b, the docking station 30 is preferably designed to support at least two battery units 40.

In a preferred embodiment as shown in FIGS. 1a and 1b, the docking station 30 is preferably designed for connecting to the portable device 20 and at least one, preferably at least two battery units 40 at the same time. Therefore, the electric connector 50 and the dedicated charging connectors 52 are arranged at different side-surfaces of the docking station 30.

The docking station 30 is preferably equipped with a graphical user interface 70 designed for providing information regarding the connected battery unit(s) 40 and the portable device 20. In particular, a charging state of the battery units 40 connected to the docking station 30 may be indicated. The user interface 70 may further be designed for enabling control of the device 20 when being connected to the docking station 30 and/or to provide feedback information regarding the operational state of the device 20.

The device 20 preferably comprises a housing 20a and a lid member 13 arranged at a top portion of the housing 20a. The lid member comprises an upper support surface 12 on which a receptacle 11 may be arranged. The receptacle 11 and the support surface 12 are preferably designed for enabling a support of the receptacle 11 in an operating state of the device as shown in FIG. 1a, as well as in a transport state of the device as shown in FIG. 1b.

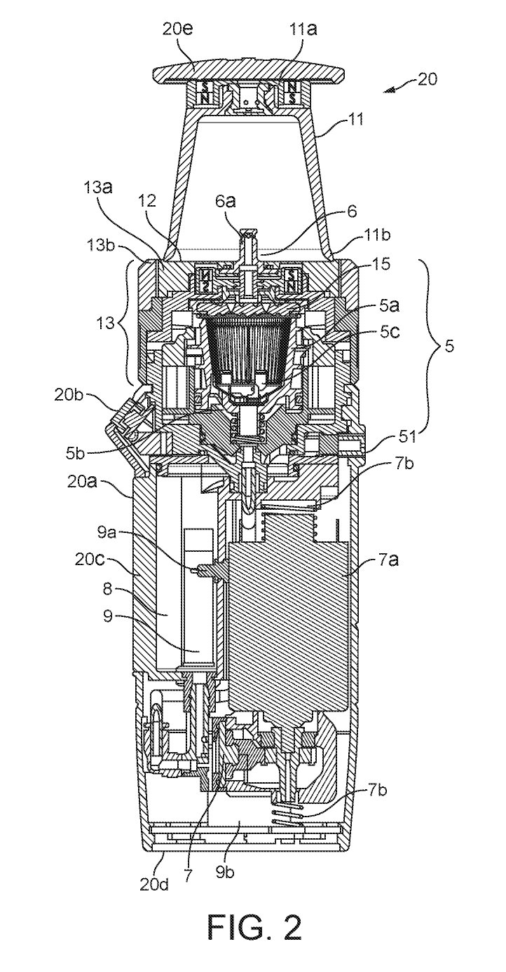

The device 20 is preferably further equipped with a user interface 20b. The user interface preferably comprises at least a start/stop button for enabling a user to selectively start and stop the beverage preparation by means of the device. The device preferably further comprises a window 20c for enabling a user to control the liquid level in a liquid reservoir 8 (see FIG. 2) of the device.

The device 20 preferably comprises an essentially vertical cylindrical form. In an operating state, the device stands on a preferably round front respective bottom surface 20d. The bottom surface 20d and a support surface 30a of the docking station 30 are preferably of conformal shape in order to guarantee a stable positioning of the device 20 when being connected to the docking station 30.

The device 20 preferably further comprises a handle 20e that is pivotally arranged at the housing 20a and extends from a central portion of the device towards an upper portion thereon. The handle 20e preferably extends upwardly beyond the support surface 12 of the lid member 13. Thereby, the handle 20e is preferably shaped to support the receptacle 11 during transport of the device such as e.g. indicated in FIG. 1b.

The handle 20e is further arranged to engage a dedicated connection surface 30b of the docking station 30 when placed on the support surface 30a thereof. Thereby, the pivotally arranged handle 20e may be pivoted from an essentially vertically extending position as shown in FIG. 1b to a slightly tilted orientation as indicated in FIG. 1a, in which the handle 20e engages the connection surface 30b. Accordingly, a stable positioning of the portable device 20 at the docking station 30 is enabled.

FIG. 2 relates to a sectional side view of the device 20 in a transport or storage mode thereof. Thereby, the receptacle 11 is placed with its circumferential upper edge 11b on the support surface 12 of the device. The support surface 12 may have dedicated engagement means such as a circular protrusion enabling a clamping engagement with the edge 11b of the receptacle. As further indicated in the figure, the handle 20e is arranged to press against the bottom 11a of the receptacle. Accordingly, the receptacle 11 may be safely retained between the handle 20e and the support surface 12 of the device during transport and storage.

The device comprises a pump 7 such as a membrane pump, and which is connected to a motor 7a. The pump 7 and/or the motor 7a are preferably vibration-decoupled from the housing 20, e.g. by means of springs 7b. The device further comprises a liquid reservoir 8 that is in fluid connection with the pump 7, and heating means 9. The heating means 9 are arranged within the liquid reservoir 8 and may comprise a temperature sensor 9a. The heating means 9 are designed for selectively heating the liquid volume contained within the liquid reservoir 8 to a desired temperature. The device preferably also comprises a control unit 9b connected to at least the pump 7, the heating means 9 and the user interface 20b.

The device further comprises a beverage brewing unit 5 preferably arranged at an upper portion of the device 20. The brewing unit 5 preferably comprises a capsule injection cage 5a that has a conformal shape to a capsule 10 to be received therein. The injection cage 5a preferably has an essentially bell-shaped form at which circumference linear protrusions may be formed as indicated in the figure. These may enable a facilitated removal of the capsule from the cage 5a after beverage preparation.

The brewing unit 5 further comprises liquid inlet means 5b connected to the liquid reservoir 8, the pump 7 and the heating means 9 of the device. The brewing unit 5 preferably also comprises opening means 5c such as a piercing member or cutting blade, which is adapted for opening an inlet face 10a of a capsule 10 if placed within the brewing unit 5.

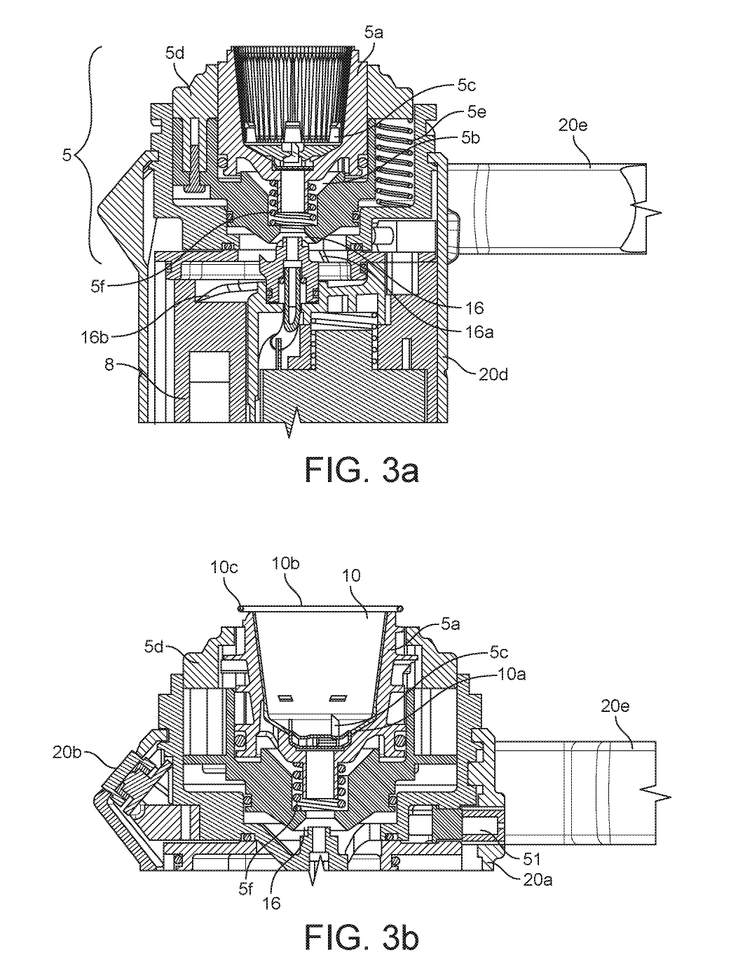

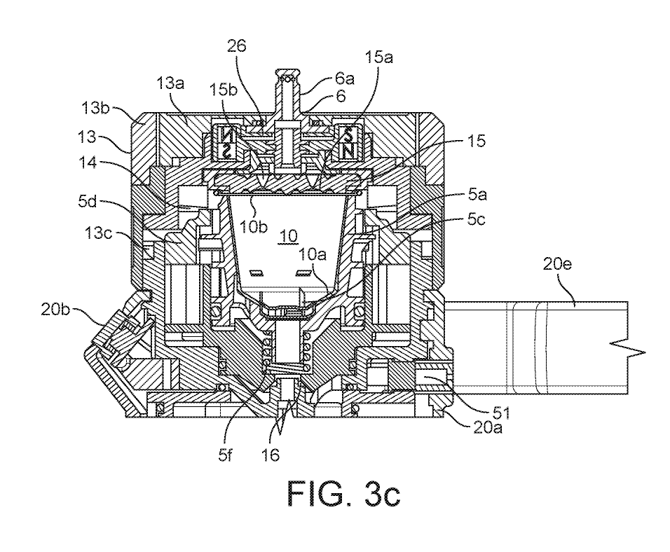

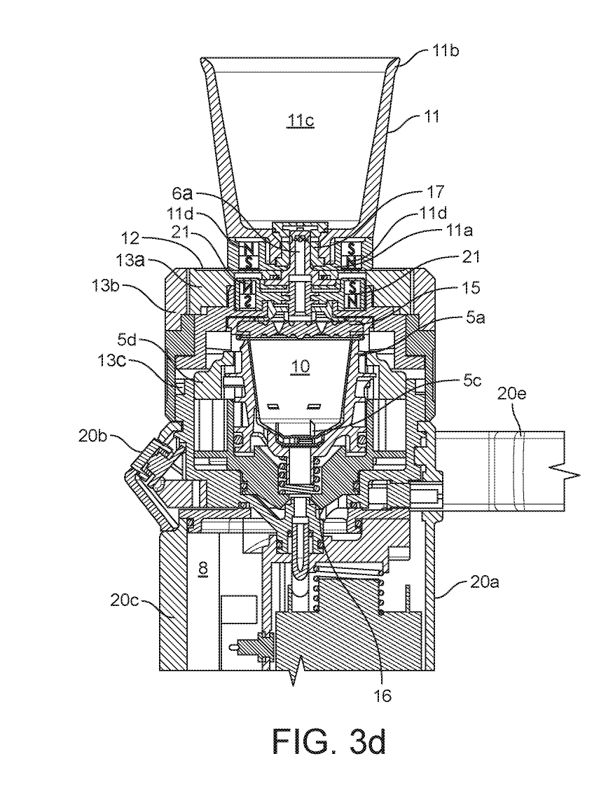

An upper portion of the brewing unit 5 is preferably formed by the removable lid member 13 which may be selectively connected to the lower portion of the brewing unit 5. The lid member 13 comprises an outer circumferential lid portion 13b and an inner central lid portion 13a which are arranged freely rotatable relative to each other. The lid member 13, in particular the inner central lid portion 13a is equipped with opening means 15 arranged for opening an outlet face 10b of the capsule 10 during the beverage preparation process. The opening means 15 is preferably a pyramidal plate comprising a horizontally arranged base plate from which a plurality of small protrusions 15a are directed downwards in direction of the outlet face 10b of the capsule 10 (see FIG. 3c). In case of increasing pressure within the capsule 10, an outlet face 10b thereof will be urged against the pyramidal plate 15 and will then tear at its protrusions 15a. The pyramidal plate 15 further comprises small liquid channels 15b enabling a fluid flow from the plate 15 towards a beverage dispensing means 6 of the lid member 13.

The beverage dispensing means 6 are preferably comprised by the lid member 13 and enable a fluid flow from the beverage brewing unit 5 towards the receptacle 11. The dispensing means 6 are arranged vertically above the brewing unit 5 of the device. The dispensing means 6 comprise an injection member 6a protruding from the support surface 12 for the receptacle 11. The injection member 6a is preferably arranged central at the support surface 12.

FIG. 3a relates to a sectional side view of the device when the lid member 13 was removed from the housing 20.

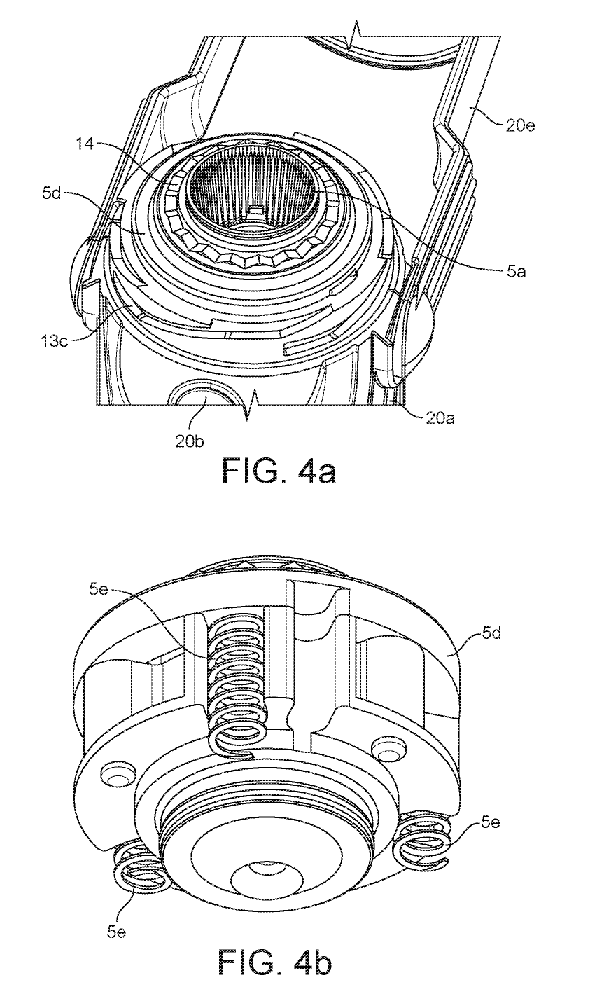

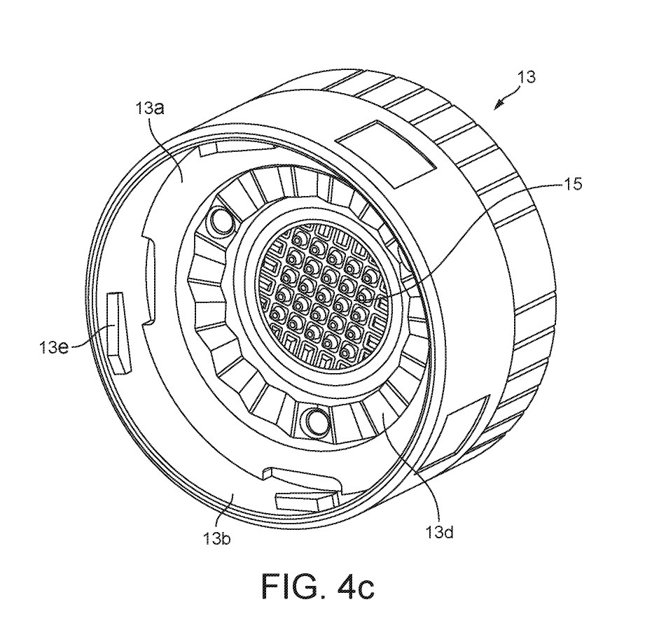

The beverage brewing unit 5 is preferably arranged movable within the housing 20a. In particular, an external cage block 5d (see also FIG. 4b) holding the capsule injection cage 5a is arranged movable within the device 20. The injection cage 5a in preferably also arranged movable with respect to the cage block 5d, e.g. by means of a central spring member 5f.

The cage block 5d holding the injection cage 5a is preferably arranged vertically movable within the housing 20 by means of dedicated resilient means 5e such as e.g. springs. The springs 5e are preferably homogenously arranged at the circumference of the cage block 5d (see also FIG. 4b). The cage block 5d is preferably moveable between a lower position as shown in FIG. 2 in case of the lid member 13 being connected to the housing 20a and an upper position as shown in FIG. 3a, when no lid member 13 is connected to the housing 20. In its upper position, a fluid passage 16 between the injection cage 5a and the liquid reservoir 8 is opened. In particular an annular passage 16 is provided in the fluid communication from the pump 7 to the injection cage 5a, which enables the direction of fluid provided into the injection cage 5a to the liquid reservoir 8. Thereby, dedicated guiding means such as a liquid passage 16a and a guiding channel 16b are in fluid communication with the annular passage 16 in order to re-direct fluid provided from above in the injection cage 5a to the liquid reservoir 8. The cage block 5d may further comprise air exhausting means 25 (see FIG. 4b) designed for enabling a circulation of air between the liquid reservoir 8 and the exterior of the housing 20. According to such arrangement, the user may remove the lid member 13 from the brewing unit 5 and may fill liquid such as water directly into the capsule injection cage 5a for re-filling the liquid reservoir 8. As an alternative to such arrangement, a dedicated refill-aperture may be provided at the housing 20a of the device.

FIG. 3b relates to a sectional side view of the device 20 when a capsule 10 comprising beverage ingredients has been provided to the capsule injection cage 5a. The capsule 10 is preferably made from aluminium. However, the capsule may as well be made from plastic or biodegradable material. The capsule 10 preferably comprises a rotational-symmetric truncated-cone shaped body having an inlet face 10a and an outlet face 10b. The outlet face 10b is connected to a circumferential flange-like rim portion 10c of the capsule. Opening means 5c of the injection cage 5a are arranged to open respectively pierce the inlet face 10a of the capsule as depicted in FIG. 3b. When inserted into the device 20, the capsule outlet face 10b is arranged at an uppermost portion of the capsule. The inlet face 10a is arranged at a lowermost portion of the capsule.

In case the lid member 13 is re-connected to the housing 20a as shown in FIG. 3c, the capsule 10 as previously provided to the capsule cage 5a is enclosed in the brewing unit 5 by means of the capsule cage 5a and the pyramidal plate 15 of the lid member 13. Thereby, the pyramidal plate 15 presses against the upper outlet face 10b. The lid member 13 may be connected to the housing 20a by means of a helical path 13c enabling a translatory motion of the lid member in downwards direction upon rotation of the outer part 13b of the lid member 13 with respect to housing 20a. Note that the liquid passage 16 between the capsule injection cage 5a and the liquid reservoir 8 is (re-)closed due to the external cage block 5d being pushed in a downward direction as the lid member 13 is connected to the housing 20a.

Further, upon (re-)connecting the lid member 13 with the housing 20a, the inner lid portion 13a will interact with rotation-prevention means 14 arranged at the beverage brewing unit 5 and in particular at the external cage block 5d thereof (see also FIG. 4a), in order to prevent a relative movement of the inner lid portion 13a and the capsule 10 arranged within the beverage brewing unit 5. Thereby, the inner lid portion 13a may comprise dedicated serrations or protrusions 13d (see FIG. 4c) that interact with the rotation-prevention means 14 of the brewing unit 5. Due to the inner portion 13a being freely rotationally movable with respect to the outer portion 13b of the lid member 13, a complete closure of the lid member 13 onto the housing 20a is enabled. When the lid member 13 is then disengaged from the housing 20a after the beverage preparation, the central portion of the lid member 13 is prevented from rotation with respect to the capsule 10 and thus, the pyramidal plate 15 is prevented from further rupturing respectively from destroying the outlet face 10b of the capsule 10.

FIG. 3d relates to an operating position of the beverage preparation device 20 according to the invention. Thereby, the receptacle 11 is connected to the beverage dispensing means 6 of the device. This is obtained via valve means 17 arranged in a bottom portion 11a of the receptacle 11 which interact with the injection member 6a of the dispensing means 6. In particular, the injection member 6a when being connected to the bottom portion 11a urges the valve means 17 upwardly in order to enable a fluid communication between the injection member 6a and the interior of the receptacle 11c.

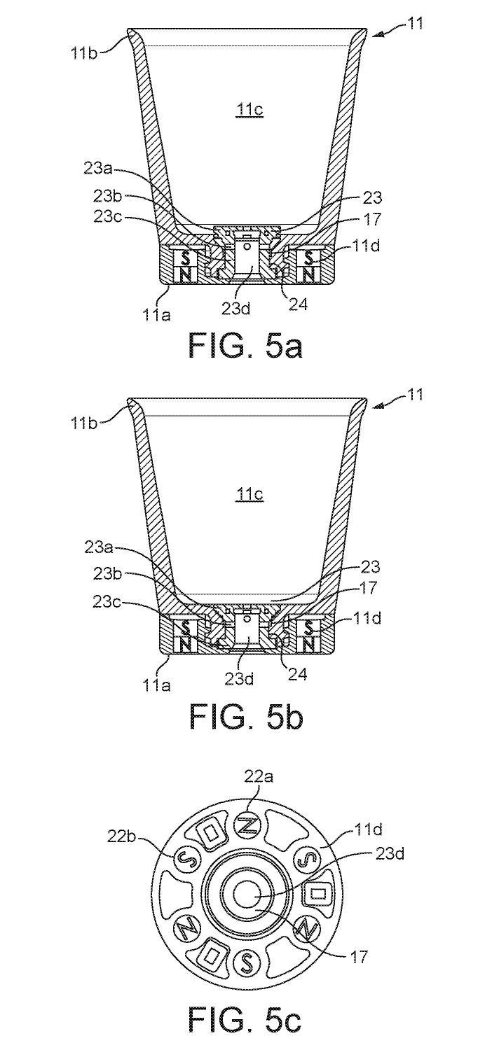

The receptacle 11 preferably comprises magnetic connecting members 11d that are designed to interact with magnetic connecting members 21 arranged at or below the support surface 12 of the lid member 13 when the receptacle is placed into the support surface 12. Accordingly, a magnetic force will attract the receptacle 11 towards the support surface 12 and thus, a stable connection between the receptacle 11 and the support surface 12 is ensured. The magnetic members 11d within the receptacle 11 and/or the lid member 13 may have an alternating polarity about the circumference of the preferably circular arrangement (see also FIG. 5c). Accordingly, the user may rotate the receptacle 11 in the support surface 12 in order to arrange for an equal polarity being present between the receptacle 11 and the lid member 13, thus leading to a separating force between the receptacle and the support surface 12. Hence, after beverage preparation, the user may rotate the receptacle 11 to facilitate removal from the surface 12.

In case the user starts the beverage preparation by means of the user interface 20b, the heating means 9 will heat the liquid volume contained within the liquid reservoir 8 of the device. After a desired and predefined temperature of the liquid is reached, the pump 7 will then be activated in order to provide heated pressurized liquid, in particular water, into the beverage brewing unit 5 via dedicated tubing of the device. The liquid will be provided to the capsule cage 5a, to the opening(s) created within the inlet face 10a of the capsule 10 and thus to the interior of the capsule 10. The pressure rise within the capsule leads to a deformation of the outlet face 10b against the pyramidal plate 15 due to which the outlet face 10b ruptures. A beverage resulting from the interaction of the liquid with the ingredients contained in the capsule 10 will then be urged upwardly, against gravity, in direction of the beverage dispensing means 6. Due to the established connection between the dispensing means 6 and the interior of the receptacle 11, the resulting beverage will be provided through the bottom portion 11a of the receptacle 11 into the interior 11c thereof. The control unit 9b of the device preferably stops the provision of liquid to the brewing unit 5 after a predefined amount of liquid was provided thereto. Due to the direct provision of the resulting beverage through the bottom portion 11a of the receptacle, spilling of the beverage is effectively prevented. It is noted that the fluid flow of the beverage in particular from the brewing unit 5 to the interior 11c of the receptacle 11 is preferably in a common direction, in particular in a direction essentially opposite to gravity. Accordingly, the fluid flow direction preferably does not change from in particular the brewing unit 5 to the receptacle 11.

FIG. 4a relates to a perspective side view onto the capsule cage block 5d and the capsule injection cage 5a when being inserted into the housing 20a of the device. As can be seen in the figure, serrations 14 are preferably arranged about the circumference of an upper surface of the capsule cage block 5d, which act as rotation-prevention means when being engaged by the central portion 13a of the lid member 13.

FIG. 4b relates to a perspective side view onto the capsule cage block 5d when being disconnected from the housing 20a. The cage block 5d comprises springs 5e arranged about the circumference of the block 5d and which are designed to urge the cage block 5d in an upwards direction in case the lid member 13 is not connected to the housing 20a.

FIG. 4c relates to perspective bottom view of the lid member 13 in which the annular protrusions respectively serrations 13d are indicated. The serrations 13d protrude from a lower surface arranged at the circumference of the pyramidal plate 15 and are designed to interact with serrations 14 of the cage block 5d (see FIG. 4a). As shown in the figure, an inner surface of the outer lid portion 13b comprises connecting members 13e designed to interact with recessions 13c at the housing 20a of the device (see FIG. 3d) for connecting the lid member 13 to housing 20a.

FIGS. 5a and 5b show the receptacle 11 designed for being connected to device 20. Thereby, FIG. 5a shows the valve means 17 of the receptacle in their open state and FIG. 5b relates to the valve means 17 being closed.

The valve means 17 preferably comprises an elastic part 23 that is extensible in vertical length when engaged by the beverage injection member 6a of the beverage dispensing means 6 of the device 20. Thereby, the elastic part 23 preferably comprises a lower part 23c that is fixed within an essentially vertical aperture 24 provided in the bottom portion 11a of the receptacle. Upon extension of the part 34 in an upwards direction due to the injection member 6a (not shown in the figure) being introduced into a vertical bore 23d of the part 23, an upper portion 23a of the part 23 extends beyond the vertical aperture 24 in the bottom portion 11a of the receptacle, such that fluid communication between the interior 11c of the receptacle 11 and the vertical bore 23d is enabled due to radially extending bores 23b within the elastic part 23. When the valve means 17 are disengaged from the protruding injection member 6a, the elastic part 23 will retract and thus close the radially extending bores 23b. Further, any liquid provided to the interior 11c will exert a downwards-directed force onto the part 23 in order to keep the valve means 17 closed.

FIG. 5c shows a bottom view of the receptacle 11, in which the magnetic members 11d are indicated with their different polarities 22a,22b as described above. In particular, the magnetic members 11d are provided in circular arrangement about at the bottom portion 11a of the receptacle 11. Thereby, the differing polarities 22a,22b relating to North and South pole of a magnet are arranged to alternate within the circular arrangement.

It is noted that although the present invention has been described with reference to preferred embodiments thereof, many modifications and alternations may be made by a person having ordinary skill in the art without departing from the scope of this invention which is defined by the appended claims.

1. A portable beverage preparation device for preparing a beverage from an ingredients containing capsule, the device comprising:
a beverage brewing unit for receiving the capsule and preparing the beverage from the ingredients within the capsule by means of injection of liquid into the capsule,
a liquid reservoir designed for holding a predefined liquid volume suitable for preparing the beverage,
a pump unit adapted for providing pressurized liquid to the beverage brewing unit, and
heating means arranged within the liquid reservoir and adapted for heating the liquid volume,
wherein the device further comprises a multifunctional connector adapted for selectively connecting the device electrically and mechanically to a remote power source.

2. The device according to claim 1, wherein the liquid reservoir is designed for holding a volume of liquid suitable for preparing a single serving of the beverage.

3. The device according to claim 1, wherein the liquid reservoir comprises a volume of between 30 to 60 ml.

4. The portable beverage preparation device according to claim 1, wherein the multifunctional connector is adapted for electrically and mechanically connecting the device to two or more of the group consisting of a docking station, a battery unit, and a low voltage power cable.

5. The portable beverage preparation device according to claim 1, wherein the device is adapted for being operated by a DC input current supplied by the multifunctional connector.

6. The portable beverage preparation device according to claim 1, wherein the device is adapted for mobile use in conjunction with the battery unit, for virtual mobile use, and for stationary use in conjunction with the docking station.

7. The portable beverage preparation device according to claim 1, wherein the pump of the device is a membrane pump that is preferably vibration-decoupled from a housing of the device.

8. The portable beverage preparation device according to claim 1, wherein the device further comprises beverage dispensing means for selectively connecting to a receptacle and for dispensing the resulting beverage from the brewing unit to the receptacle.

9. The portable beverage preparation device according to claim 8, wherein the beverage dispensing means protrude from a support surface for a receptacle arranged above the brewing unit.

10. The portable beverage preparation device according to claim 1, wherein the brewing unit is arranged above the liquid reservoir and the pump in the beverage preparation device.

11. A kit, comprising:
a beverage preparation device according to any of claims 1 to 10;
a docking station; and
a battery unit;
wherein the docking station and the battery unit comprise the same connection means adapted for being selectively connected electrically and mechanically to the multifunctional connector of the device.

12. The kit according to claim 11, wherein the kit further comprises a low voltage power cable and/or a car power adapter having the same connection means than the docking station and the battery unit and which are adapted for being electrically and mechanically connected to the multifunctional connector of the device.

13. The kit according to claim 11, wherein the kit further comprises a receptacle designed for being selectively connectable to a dedicated dispensing means of the device.

14. The kit according to claim 13, wherein the device and/or the receptacle are adapted for being selectively connectable in at least two different positions, a beverage delivery position and a receptacle storage position.

15. The kit according to claim 11, wherein the docking station comprises at least one charging member to which the electrical connection means of the battery unit of the system may be connected for charging.
